(19) United States
(12) Patent Application Publication
(10) Pub. No.: US 2010/0172637 A1
(43) Pub. Date: Jul. 8, 2010

(54) OVEN

(75) Inventors: TING-BA LIN, Tai Pei County (TW); HEI-WANG LEE, Tainan City (TW); GUIWEI WU, Fujian Province (CN)

Correspondence Address: RABIN & Berdo, PC, 1101 14TH STREET, NW, SUITE 500, WASHINGTON, DC, 20005, US

(73) Assignee: TSANN KUEN (ZHANGZHOU) ENTERPRISE CO., LTD., FUJIAN PROVINCE (CN)

(21) Appl. No.: 12/684,199

(22) Filed: Jan. 8, 2010

(30) Foreign Application Priority Data
Jan. 8, 2009 (CN) 200910110835.1

(51) Int. Cl. F27B 5/06

(52) U.S. Cl. 392/416

(57) ABSTRACT

The present invention relates to an oven which could heat food with light waves. In the oven of the present invention, the chamber is disposed in the housing, and both the chamber and the housing have an opening in the same direction; a first heat unit is disposed between the chamber and the housing; a gate is disposed on the openings of the housing and the chamber; the chamber has an arc surface; an interior pot with an arc surface is disposed in the chamber; the light waves, and the light waves generated and radiated by the first heat unit are reflected many times between the chamber and the interior pot, so the light waves could be absorbed by the interior pot so as to heat the food stuff by the heat which is conducted by the interior pot and the light waves which is radiated by the interior pot more efficient.

### FIELD OF THE INVENTION

The present invention relates to an oven which could heat food with light waves.

### BACKGROUND OF THE INVENTION

Typically, the conventional oven comprises a housing, a chamber, a heat unit and a gate. The chamber is disposed in the housing, and the openings of the chamber and the housing are in the same direction; the heat unit is disposed between the chamber and the housing. The light waves generated and radiated by the heat unit heat food. The gate is disposed on the openings of the housing and the chamber so that it is convenient to put food in or take food from the oven. Because the chamber is often in the shape of rectangle or semicircle, the reflection of the light waves are not even, so that the character of light that light propagates in straight-line could not be efficiently used in radiation heat food. The conventional oven which heats food with light waves has the problem that the loss in reflection of light waves is too heavy.

### SUMMARY OF THE INVENTION

The purpose of the present invention is to provide an oven in which the light waves generated and radiated by light units could be reflected many times in chamber, so that the light waves could be absorbed by food.

The technical solution applied by the present invention is: an oven that comprises a housing provided with an opening, a chamber disposed in the housing and provided with an opening in the same direction to the opening of said housing, a first heat unit is disposed between said chamber and said housing, a gate is disposed on the openings of said chamber and said housing; wherein said chamber has an arc surface and an interior pot with an arc surface; wherein the light waves generated and radiated by said first heat unit are reflected many times between said chamber and said interior pot so as to heat the food stuff by the heat which is conducted by the interior pot and the light waves which is radiated by said interior pot. The interior pot shortens the distance of the reflection of light waves in order that the loss in the radiation is reduced and the efficiency of light waves is increased.

The cross-section of said chamber is in the shape of quasi-rectangle and the four angles of said cross-section are made into arc surfaces so as to make the light waves radiated by said first heat unit reflected many times between said chamber and said interior pot. The chamber is easily manufactured with a mold and the effect of the reflection of the light waves is better.

The interior surface of said gate is an arc surface. The gate could absorb the reflected light waves, so that the efficiency of the light waves is improved.

Said chamber and said housing respectively comprise a window facing the opening of said interior pot is disposed on the top of said chamber and said housing, and a cover is disposed to cover the window. User could put food into the interior pot directly or take food from the interior pot through the window. So the operation of the oven is flexible and humanized.

A second heat unit disposed on said cover can heat food directly by radiation in order to speed up processing food.

The oven includes an electric controller which could respectively control said first heat unit and said second heat unit. According to different food, user can set different parameters of heat time sequence and power to make said first heat unit and said second heat unit to work according to the parameters.

Said interior pot is made from metal or pottery or graphite. The metal interior pot fits for rapid heating food, while the pottery interior pot fits for slow heating food.

Material, which could absorb heat is daubed on the exterior surface of said interior pot. So the efficiency of photothermal conversion is increased.

An arc reflector is disposed behind said first heat unit, and the reflection surface of the arc reflector near the first heat unit is processed for diffuse reflection. The arc reflector can make the light waves from the first heat unit reflected to the chamber uniformly and adequately.

In the oven of the present invention, the chamber has an arc surface; the chamber has an interior pot with an arc surface; the first heat unit radiates light waves, and the light waves are reflected many times between the chamber and the interior pot so as to heat the food stuff by the heat which is conducted by said interior pot and the light waves which is radiated by the interior pot. The interior pot shortens the distance of the reflection of light waves in order that the loss in the radiation is reduced and the efficiency of light waves is improved. Because the rate of absorption of light waves is increased, energy is saved and the time of processing food is obviously shortened. With several experiments, compared to the conventional technique, the oven of the present invention could save 30% electric energy and 25%-30% time. For a pot disposed in the chamber, the oven of the present invention can not only be used for baking food, but also be used for cooking food, such as cooking porridge and braising rice, so its application scope is expanded.

### BRIEF DESCRIPTION OF THE DRAWINGS

FIG. 1 is a three-dimension view of the oven of the new type of the present invention in a preferred embodiment.

FIG. 2 is a front sectional view of the oven in FIG. 1.

FIG. 3 is a side sectional view of the oven in FIG. 1.

FIG. 4 is a horizontal sectional view of the oven in FIG. 1.

FIG. 5 is a schematic diagram of the electric controller of the oven in FIG. 1.

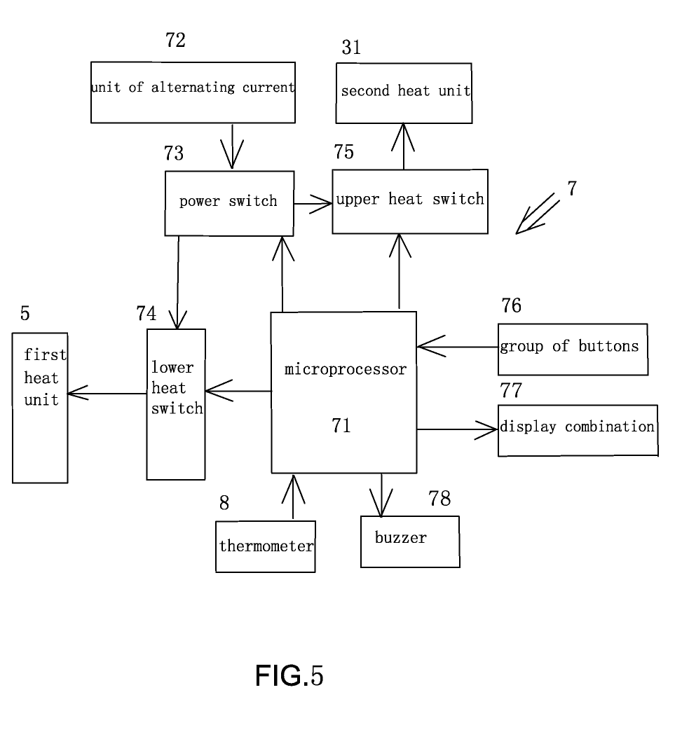

### DESCRIPTION OF SPECIFIC EMBODIMENTS

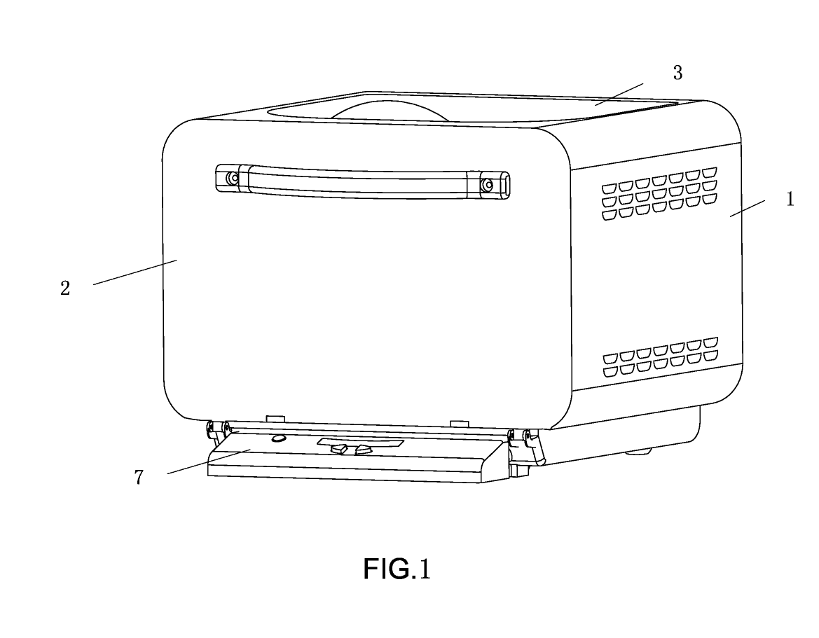

Referring to FIGS. 1 to 4, the oven of the present invention in a preferred embodiment comprises a housing 1, a gate 2, a cover 3, a chamber 4, a first heat unit 5, a interior pot 6, a electric controller 7, and a thermometer 8.

The housing 1 is rectangular and is opened in the front; a window is disposed on the top of the housing 1. The gate 2 is hinged to the bottom of the housing 1.

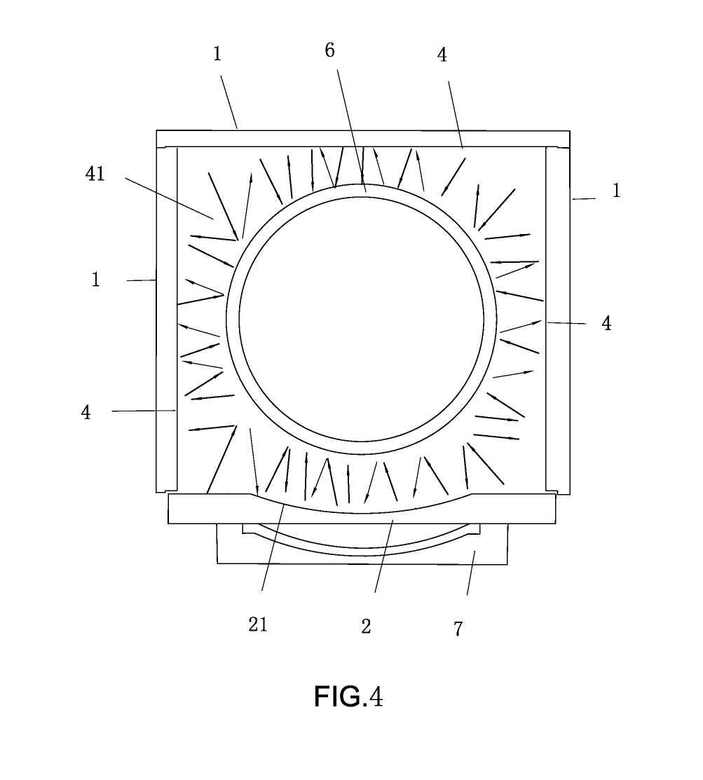

Referring to FIG. 4, an arc surface 21 is disposed in the interior surface of the gate 2. The radian of the arc surface is 145°±10°, and the radian could make a reflection effect like a small sun in order to increase the efficiency of light waves and save energy.

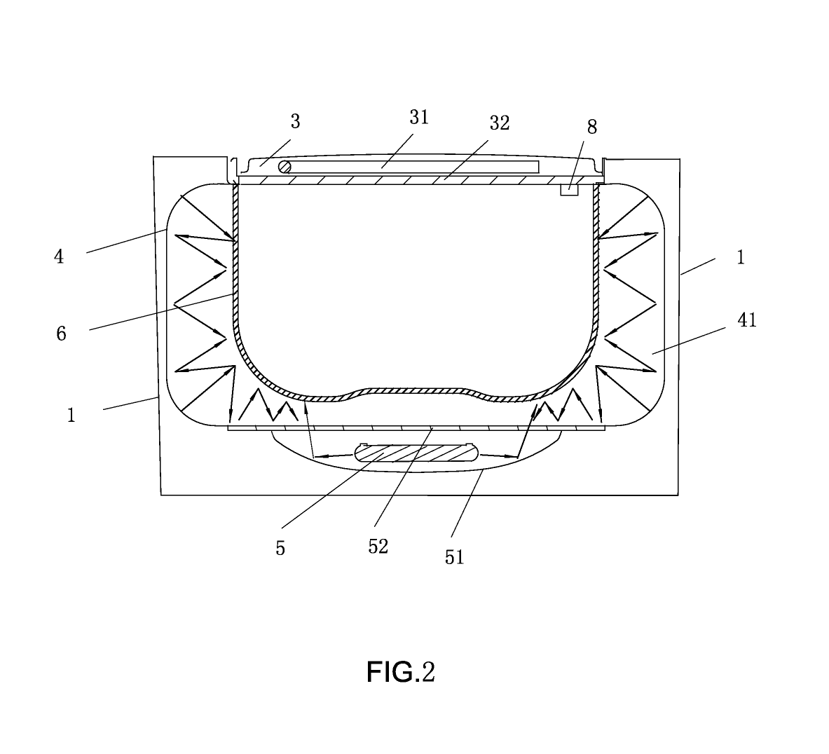

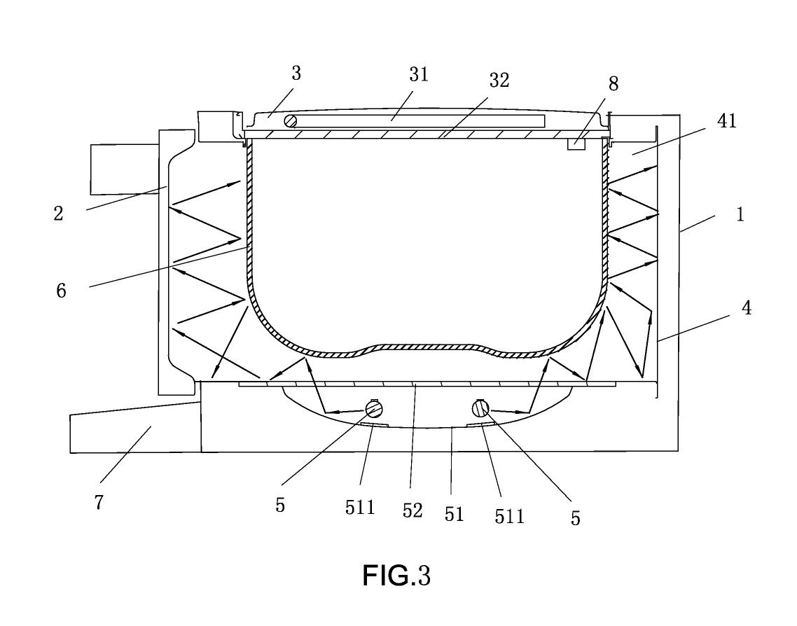

Referring to FIG. 2 and FIG. 3, the cover 3 is in the shape of a box and its bottom faces downwards. A light-reflection plate is disposed on the bottom of the cover 3. And the cover 3 has a second heat unit 31 in it and the second heat unit 31 is a circular halogen fluorescent tube. The opening of the cover 3 faces an upper glass plate 32 disposed in the chamber 4.

Referring to FIG. 2, FIG. 3 and FIG. 4, the anterolateral surfaces of the chamber 4 is opened outside, and could be sealed by the gate 2. The cross-section of the chamber 4 is in the shape of quasi-rectangle whose four angles are made into arc surfaces. Each of the upper side and the lower side of the chamber 4 has a window.

The chamber 4 is disposed in the housing 1. The upper window of the chamber 4 corresponds with the window in the top of the housing 1. The cover 3 is hinged to the window of the housing 1 to cover the window of the housing 1 and the upper window of the chamber 4.

The first heat unit 5 is disposed between the lower window in the bottom of the chamber 4 and the bottom of the housing 1; the first heat unit 5 comprises two circular halogen fluorescent tubes, which have more power. An arc reflector 51 is disposed under the first heat unit 5, and reflection surface of the arc reflector 51 near the first heat unit is processed for diffuse reflection. The process for diffuse reflection includes frosting and adding diffuse reflection strip. Of course, the light-reflection plate of the second heat unit 31 could also be processed for diffuse reflection. A lower glass plate 52 faces the lower window in the bottom of the chamber 4 and is disposed in the opening of the reflector 51, in order that the light waves from the first heat unit 5 can enter directly the chamber 4.

The upper window of the chamber 4 faces the upper glass plate 32 of the cover 3, in order that the light waves from the second heat unit 31 can enter directly the chamber 4 and the opening of the interior pot 6.

The interior pot 6 is made from metal or pottery or graphite, and the bottom and side of it is arc curved surface. Material, which could absorb heat especially ultrared rays, is daubed on the exterior surface of the interior pot 6.

The electric controller 7 can respectively control the first heat unit 5 and the second heat unit 31. FIG. 7 illustrates the frame structure of the electric controller 7.

The core of the electric controller 7 is a microprocessor 71. The parameters and the control orders from the group 76 of buttons are the first input group of the microprocessor 71. The temperature signals in the chamber 4 offered by the thermometer 8 are the second input group of the microprocessor 71.

The first output group of the microprocessor 71 controls the power switch 73 to decide whether the electric energy offered by the unit of alternating current could be transmitted to the lower heat switch 74 and the upper heat switch 75. The second output group of the microprocessor 71 controls the lower heat switch 74 and makes it to work according to certain heat time sequence and power, so that the electric energy from the power switch 73 could be transmitted to the first heat unit 5. The third output group of the microprocessor 71 controls the upper heat switch and makes it to work according to certain heat time sequence and power, so that the electric energy from the power switch 73 could be transmitted to the second heat unit 31. The forth output group of the microprocessor 71 controls display combination 77 and make it to work according to requirements in order to provide necessary tips to users. The fifth output group of the microprocessor 71 controls buzzer 78 and make it to sound according requirement.

The thermometer 8 is disposed on the upper glass plate 32 of the cover 3, facing the opening of the interior pot 6 and not close to the second heat unit 31.

When using the oven, according to different food, user could input parameters and orders with the group 76 of buttons to set the heat time sequence and the power of the oven. Then open the gate 2, and put the interior pot 6 in the chamber 4 and user can put food into the interior pot 6 through the cover 3.

After the gate 2 is closed, the microprocessor 71 controls the power switch 73 to connect to the unit 72 of alternating current, controls the lower heat switch 74 to transmit electric energy to the first heat unit 5, and controls the upper heat switch 75 to transmit electric energy to the second heat unit 31. And the first heat unit 5 and the second heat unit 31 can radiate light waves according to the designed heat time sequence and the designed power. With the reflector 51, the light wave 2s generated and radiated by the first heat unit 5 can pass through the lower glass plate 52 and directly enter the interior 41 of the chamber 4. The arc surface with four angles of the chamber 4 makes the light waves from the first heat unit 5 to reflect many times in the space 41 between the chamber 4 and the interior pot 6 and then the light waves are all absorbed by the interior pot 6. The interior pot 6 in the chamber 4 reduces the distance of the reflection of light waves from the first heat unit 5 in order that the loss in the radiation is reduced and the efficiency of light waves is increased. The arc curved surface 21 in the interior of the gate 2 can assemble reflection light waves in order to increase the efficiency of the light waves. The food in the interior pot 6 is sufficiently heated by the heat which is conducted by the interior pot 6 and the light waves which is radiated by the interior pot 6. With light-reflection plate, the light waves from the second heat unit 31 can thoroughly pass through the upper glass plate 32 and directly enter the interior pot 6 in the chamber 4 to heat the food in the interior pot 6 in order to speed up the processing food.

For example, when braising rice, user can control the first heat unit 5 and the second heat unit 31 to heat water and rice in the interior pot 6 simultaneously. Then close the first heat unit 5 when water is boiled and keep the second heat unit 31 heating water and rice in the interior pot 6 until rice is cooked. User also could cook soup in this way. In some conditions, user could only use the first heat unit 5 for high-temperature heating the food in the interior pot 6 and then use it for low-temperature heating the food.

When the temperature in the interior pot 6 is beyond the designed temperature scope, the thermometer 8 sends a signal to the microprocessor 71 which controls the upper heat switch 75 and the lower heat switch 74, in order that the first heat unit 5 or the second heat unit 31 loses electric energy and stops heating. When the temperature in the interior pot 6 is beyond the designed safety scope, the thermometer 8 sends a signal to the microprocessor 71 and the microprocessor 71 adopts an emergency treatment to control the power switch 73 cut off the connection between the unit 72 of alternating current and the upper heat unit 75, and cut off the connection between the unit 72 of alternating current and the lower heat unit 74. So the two heat units stop heating and at the same time the microprocessor 71 controls the buzzer 78 to make sounds in order to protect the oven.

When the food is cooked, user can take it from the interior pot 6 through the cover 3. Then put food into the interior pot 6 without opening the gate 2 and take the interior pot 6 from the oven.

It takes about 37-40 minutes to use the oven to bake potatoes (200 g×3). Compared to conventional ovens, the oven in the present invention saves 25% time and 30% electric energy. It takes about 14-23 minutes to use the oven to bake chicken legs (100 g×3). Compared to conventional ovens, the oven in the present invention saves 30% time and 30% electric energy. When processing other food, the oven can also save time and energy obviously.

All above is only the preferred embodiment of the present invention. However, the present is not limited in the preferred embodiment and all the alternations and modifications of the present invention should be in the scope of the present invention.

What is claimed is:

1. An oven, comprises a housing provided with an opening, a chamber disposed in said housing, and the openings of the chamber and provided with an opening in the same direction to the opening of said housing, a first heat unit is disposed between said chamber and said housing, a gate disposed on the openings of said chamber and said housing; wherein said chamber has an arc surface and an interior pot with an arc surface; wherein the light waves generated and radiated by said first heat unit are reflected many times between said chamber and said interior pot, so the light waves could be absorbed by the interior pot so as to heat the food stuff by the heat which is conducted by the interior pot and the light waves which is radiated by said interior pot.

2. The oven according to claim 1, wherein the cross-section of said chamber is in the shape of quasi-rectangle and the four angles of said cross-section are made into arc surfaces so as to make the light waves radiated by said first heat unit reflected many times between said chamber and said interior pot.

3. The oven according to claim 2, wherein the interior surface of said gate is an arc surface.

4. The oven according to claim 1, wherein said chamber and said housing respectively comprise a window facing the opening of said interior pot disposed on the top of said chamber and said housing, and a cover is disposed to cover said window.

5. The oven according to claim 4, wherein a second heat unit is disposed on said cover.

6. The oven according to claim 5, wherein said oven includes an electric controller which could respectively control said first heat unit and said second heat unit.

7. The oven according to claim 1, wherein said interior pot is made from metal or pottery or graphite.

8. The oven according to claim 7, wherein the material which could absorb heat is daubed on the exterior surface of said interior pot.

9. The oven according to claim 1, wherein an arc reflector is disposed behind said first heat unit, and the reflection surface of said arc reflector near the first heat unit is processed for diffuse reflection.
